(19) United States
(12) Patent Application Publication
(10) Pub. No.: US 2025/0386875 A1
(43) Pub. Date: Dec. 25, 2025

(54) AEROSOL-GENERATING DEVICE

(71) Applicant: KT&G Corporation, Daejeon (KR)

(72) Inventors: Jueon PARK, Gyeonggi-do (KR); Younji SHIN, Seoul (KR); Jongsub LEE, Gyeonggi-do (KR); Hunil LIM, Seoul (KR); Hyungjin JUNG, Seoul (KR)

(73) Assignee: KT&G Corporation, Daejeon (KR)

(21) Appl. No.: 19/094,839

(22) Filed: Mar. 29, 2025

(30) Foreign Application Priority Data
Jun. 25, 2024 (KR) 10-2024-0082865
Aug. 30, 2024 (KR) 10-2024-0117495

(51) Int. Cl. A24F 40/57; A24F 40/40; A24F 40/90; H02M 3/156

(52) U.S. Cl. CPC A24F 40/57; A24F 40/40; A24F 40/90; H02M 3/156

(57) ABSTRACT

An aerosol-generating device is disclosed. The aerosol-generating device includes a heater configured to heat an aerosol-generating substance, a power supply configured to supply power to the heater, and a power conversion unit configured to convert a voltage output from the power supply into a voltage to be supplied to the heater, wherein the power conversion unit includes an inductor connected to the power supply, and an inductance of the inductor is 0.8 to 1.2 μH.

### CROSS-REFERENCE TO THE RELATED APPLICATION

This application claims priority from Korean Patent Application No. 10-2024-0082865, filed on Jun. 25, 2024, and Korean Patent Application No. 10-2024-0117495, filed on Aug. 30, 2024, in the Korean Intellectual Property Office, the disclosure of which is incorporated herein by reference in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance by generating an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

In an aerosol-generating device, a power conversion circuit to supply power to a heater is used. A voltage output from a battery may be converted to be suitable for a heater operating voltage through the power conversion circuit. An inductor provided in a conventional power conversion circuit has a problem in that a peak current is generated during the power conversion process, and accordingly, the operating temperature of the inductor and the power conversion circuit increases, thereby lowering the operating stability of the circuit.

### SUMMARY OF THE DISCLOSURE

It is an object of the present disclosure to solve the above and other problems.

It is another object of the present disclosure to provide an aerosol-generating device in which an inductor of a power conversion unit has an inductance within a specific range.

It is yet another object of the present disclosure to provide an aerosol-generating device in which an inductor of a power conversion unit has a DC resistance within a specific range.

It is still yet another object of the present disclosure to provide an aerosol-generating device having a circuit that cuts off power supplied to a heater based on a current value flowing through the heater.

In accordance with the present disclosure, the above and other objects can be accomplished by the provision of an aerosol-generating device including a heater configured to heat an aerosol-generating substance, a power supply configured to supply power to the heater, and a power conversion unit configured to convert a voltage output from the power supply into a voltage to be supplied to the heater, wherein the power conversion unit includes an inductor connected to the power supply, and an inductance of the inductor is 0.8 to 1.2 μH.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram of an aerosol-generating device according to one embodiment of the present disclosure;

FIGS. 2 and 3 are views showing aerosol-generating devices according to embodiments of the present disclosure;

FIG. 4 is a front perspective view of an aerosol-generating device according to one embodiment of the present disclosure;

FIG. 5 is a circuit diagram of the aerosol-generating device according to one embodiment of the present disclosure;

FIG. 6 is a circuit diagram of a power conversion unit of the aerosol-generating device according to one embodiment of the present disclosure;

FIG. 7 is a graph comparatively representing a peak current depending on the inductance of an inductor of the power conversion unit of the aerosol-generating device according to one embodiment of the present disclosure;

FIGS. 8A and 8B are images showing a temperature to which the power conversion unit is heated depending on the inductance of the inductor of the power conversion unit of the aerosol-generating device according to one embodiment of the present disclosure;

FIG. 9 is a flowchart illustrating power cutoff control of a heater of the aerosol-generating device according to one embodiment of the present disclosure; and

FIG. 10 is a circuit diagram of an aerosol-generating device according to one embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, singular forms are intended to include plural forms as well, unless the context clearly indicates otherwise.

Embodiments as set forth herein may be implemented as software including one or more instructions that are stored in a storage medium (e.g., a memory 17) that is readable by a machine (e.g., an aerosol-generating device 1). For example, a processor (e.g., a controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In the present disclosure, the directions of the aerosol-generating device 1 may be defined based on an orthogonal coordinate system. In the orthogonal coordinate system, the x-axis direction may be defined as a leftward-rightward direction of the aerosol-generating device 1. The y-axis direction may be defined as a forward-backward direction of the aerosol-generating device 1. The z-axis direction may be defined as an upward-downward direction of the aerosol-generating device 1.

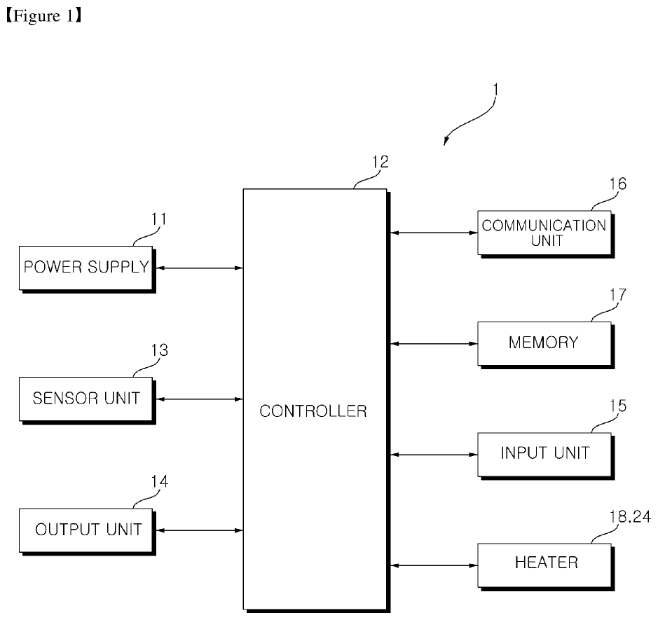

FIG. 1 is a block diagram of an aerosol-generating device according to an embodiment.

According to one embodiment, the aerosol-generating device 1 may include a power supply 11, a controller 12, a sensor unit 13, an output unit 14, an input unit 15, a communication unit 16, a memory 17, and/or a heater 18 and 24. However, the components included in the aerosol-generating device 1 are not limited to those shown in FIG. 1. That is, it will be understood by those skilled in the art related to the present embodiment that some of the components shown in FIG. 1 may be omitted or new components may be further included depending on the design of the aerosol-generating device 1.

According to one embodiment, the sensor unit 13 may detect the state of the aerosol-generating device 1 or the state of the surroundings of the aerosol-generating device 1, and may transmit the detected information to the controller 12. For example, the sensor unit 13 may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit 13 may further include various sensors, such as a liquid residual quantity sensor for detecting the residual quantity of liquid in the cartridge and an immersion sensor for detecting immersion of the aerosol-generating device 1.

According to one embodiment, the temperature sensor may detect a temperature to which the heater 18 and 24 is heated. The aerosol-generating device 1 may include a separate temperature sensor for detecting the temperature of the heater 18 and 24, or the heater 18 and 24 itself may serve as a temperature sensor. In an example, the temperature sensor may be used to measure impedance for the heater 18. The impedance for the heater 18 may correlate with the temperature of the heater 18. The temperature sensor may measure current and/or voltage applied to the heater 18 (or an induction coil). The impedance for the heater 18 may be obtained based on the measured current and/or voltage. The controller 12 may estimate the temperature of the heater 18 based on the obtained impedance.

In an example, the temperature sensor may include a resistance element (e.g., a thermistor), the resistance value of which varies in response to changes in the temperature of the heater 18 and 24. The temperature sensor may output a signal corresponding to the resistance value of the resistance element, and the controller 12 may determine the temperature of the heater 18 and 24 and/or a change in the temperature of the heater 18 and 24 based on the signal corresponding to the resistance value.

In another example, the temperature sensor may include a sensor that detects the resistance value of the heater 18 and 24. The temperature sensor may output a signal corresponding to the resistance value of the heater 18 and 24, and the controller 12 may determine the temperature of the heater 18 and 24 and/or a change in the temperature of the heater 18 and 24 based on the signal corresponding to the resistance value.

According to one embodiment, the temperature sensor may detect the temperature of the power supply 11. The temperature sensor may be disposed adjacent to the power supply 11. For example, the temperature sensor may be attached to one surface of the power supply 11 (e.g., a battery) and/or may be mounted on one surface of a printed circuit board. In an example, the aerosol-generating device 1 may include a power supply protection circuit module (PCM), and the temperature sensor may be disposed adjacent to the power supply 11 together with the power supply protection circuit module.

According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the controller 12 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, a space into which an aerosol-generating article is inserted (hereinafter referred to as an “insertion space”), and the heater 18 and 24. The controller 12 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the controller 12 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change of the aerosol-generating article in the insertion space and/or aerosol flow may occur, and accordingly, a dielectric constant in the insertion space may change. The controller 12 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space. In addition, the insertion detection sensor may include any combination of the examples described above.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The controller 12 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The controller 12 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the controller 12 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the controller 12 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The controller 12 may determine whether the aerosol-generating article is in an overly moist state based on the level of a signal corresponding to the dielectric constant or the like output from the capacitance sensor. In an example, the controller 12 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The controller 12 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The controller 12 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The controller 12 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the controller 12 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit 13 may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit 14 may output information about the state of the aerosol-generating device 1 to provide the same to the user. The output unit 14 may include, but is not limited to, a display, a haptic unit, and/or a sound output unit. For example, information about the aerosol-generating device 1 may include a charging/discharging state of the power supply 11 of the aerosol-generating device 1, a preheating state of the heater 18 and 24, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as the input unit 15. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the power supply 11 may supply power used for operation of the aerosol-generating device 1. The power supply 11 may include one or more batteries. The power supply 11 may supply power so that the heater 18 and 24 is heated. In addition, the power supply 11 may supply power necessary for operation of the other components included in the aerosol-generating device 1, such as the controller 12, the sensor unit 13, the output unit 14, the input unit 15, the communication unit 16, and the memory 17. The power supply 11 may be a rechargeable battery or a disposable battery. For example, the power supply 11 may be a lithium polymer (LiPoly) battery without being limited thereto. The power supply 11 may be a replaceable (separation-type) battery (hereinafter referred to as a “removable battery”). The removable battery may be mounted in a battery accommodation portion provided in the aerosol-generating device 1 or may be removed from the battery accommodation portion. The removable battery may be charged in a wired and/or wireless manner.

According to one embodiment, the heater 18 and 24 may receive power from the power supply 11 to heat the aerosol-generating article (e.g., a cigarette) and/or a medium and/or an aerosol-generating substance in the cartridge. The aerosol-generating device 1 may include a heater 18 for heating the aerosol-generating article and/or a cartridge heater 24 for heating the cartridge (i.e., a solid and/or liquid medium).

According to one embodiment, the heater 18 and 24 may be an electro-resistive heater. For example, the electro-resistive heater may include an electrically resistive material such as a metal or a metal alloy including titanium, zirconium, tantalum, platinum, nickel, cobalt, chromium, hafnium, niobium, molybdenum, tungsten, tin, gallium, manganese, iron, copper, stainless steel, and nichrome. The electro-resistive heater may be implemented as a metal wire, a metal plate having an electrically conductive track disposed thereon, or a ceramic heating element.

According to one embodiment, the heater 18 and 24 may be an induction heater. For example, the induction heater may include a susceptor that generates heat through a magnetic field. A magnetic field may be generated by an induction coil by alternating current flowing through the induction coil. The magnetic field may pass through the heater, and an eddy current may be generated in the susceptor. The susceptor may be heated based on generation of the eddy current. According to one embodiment, the susceptor may be included in the inner portion (e.g., the medium portion) of the aerosol-generating article. In this case, the susceptor included in the inner portion of the aerosol-generating article may also be heated by the induction coil.

The heater 18 and 24 is not limited to the examples described above, and may include or be replaced with various heating methods, structures, and components for heating the aerosol-generating article and/or the cartridge.

According to one embodiment, the input unit 15 may receive information input from the user. For example, the input unit 15 may include a touch panel, a button, a keypad, a dome switch, a jog wheel, and a jog switch.

According to one embodiment, the memory 17 may be hardware storing various pieces of data processed in the aerosol-generating device 1. The memory 17 may store data processed and to be processed by the controller 12. For example, the memory 17 may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory 17 may store data on an operation time of the aerosol-generating device 1, the maximum number of puffs, the current number of puffs, at least one temperature profile, and the user's smoking pattern.

According to one embodiment, the communication unit 16 may include at least one component for communication with other electronic devices (e.g., a portable electronic device). For example, the communication unit 16 may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, a cellular network communication unit, an Internet communication unit, and a computer network (e.g., LAN or WAN) communication unit.

According to one embodiment, the controller 12 may control the overall operation of the aerosol-generating device 1. For example, the controller 12 may include at least one processor. The controller 12 may be implemented as an array of a plurality of logic gates or may be implemented as a combination of a general-purpose microcontroller unit (MCU) (or a microprocessor) and a memory in which a program executable by the MCU is stored. It will be understood by those skilled in the art that the controller may also be implemented as other forms of hardware.

According to one embodiment, the controller 12 may control the supply of power from the power supply 11 to the heater 18 and 24 to control the temperature of the heater 18 and 24. The controller 12 may control the temperature of the heater 18 and 24 and/or power supplied to the heater 18 and 24 based on the temperature of the heater 18 and 24 detected by the temperature sensor (e.g., the sensor unit 13). The controller 12 may control the temperature of the heater 18 and 24 and/or power supplied to the heater 18 and 24 based on the temperature profile and/or the power profile stored in the memory 17.

According to one embodiment, the controller 12 may control a power conversion circuit (not shown) electrically connected to the heater 18 and 24 and the power supply 11 to control power (e.g., voltage and/or current) supplied to the heater 18 and 24. For example, the power conversion circuit may include a DC/DC converter (e.g., a buck converter, a buck-boost converter, a boost converter, or a Zener diode) that converts power to be supplied to the heater 18 and 24 and a DC/AC converter (e.g., an inverter) that converts power to be supplied to the induction coil (not shown). The DC/AC converter may be implemented as a full-bridge circuit or a half-bridge circuit including a plurality of switching elements. For example, the power conversion circuit may include at least one switching element, such as a bipolar junction transistor (BJT) or a field effect transistor (FET).

According to one embodiment, the controller 12 may control the frequency and/or duty ratio of a current pulse input to at least one switching element of the power conversion circuit (not shown) to control the current and/or the voltage supplied to the heater 18 and 24. The duty ratio for the on/off operation of the switching element may correspond to a ratio of the voltage output from the power conversion circuit to the voltage output from the power supply 11.

According to one embodiment, the controller 12 may control power supplied to the heater 18 and 24 using at least one of a pulse width modulation (PWM) scheme or a proportional-integral-differential (PID) scheme. For example, the controller 12 may perform control using the PWM scheme such that a current pulse having a predetermined frequency (a specific frequency) and a predetermined duty ratio (a specific duty ratio) is supplied to the heater 18 and 24. The controller 12 may control the frequency and duty ratio of the current pulse to control power supplied to the heater 18 and 24. For example, the controller 12 may determine, based on the temperature profile, a target temperature to be controlled. The controller 12 may control power supplied to the heater 18 and 24 using the PID scheme, which is a feedback control scheme using a difference value between the temperature of the heater 18 and the target temperature, a value obtained by integrating the difference value with respect to time, and a value obtained by differentiating the difference value with respect to time.

According to one embodiment, the controller 12 may determine, based on the power profile, target power to be controlled. The controller 12 may control power supplied to the heater 18 and 24 so as to correspond to the preset target power over time.

According to one embodiment, the controller 12 may detect power supplied to the heater 18 and 24 to determine the user's puff. In more detail, the controller 12 may control power supplied to the heater 18 and 24 using the proportional-integral-differential (PID) scheme. When the user's puff occurs, temperature drop may temporarily occur in a space into which the aerosol-generating article is inserted (hereinafter referred to as an insertion space) and the heater 18 and 24. Accordingly, the power (or the current) supplied to the heater 18 and 24 may change during control of the power using the PID scheme. The controller 12 may determine the user's puff based on the change in the power controlled.

According to one embodiment, the controller 12 may prevent the heater 18 and 24 from overheating. For example, the controller 12 may control, based on the temperature of the heater 18 and 24 exceeding a preset limit temperature, operation of the power conversion circuit such that the amount of power supplied to the heater 18 and 24 is reduced or the supply of power to the heater 18 and 24 is interrupted.

According to one embodiment, the controller 12 may control charging/discharging of the power supply 11. For example, the controller 12 may check the temperature of the power supply 11 using the temperature sensor (e.g., the sensor unit 13). If the temperature of the power supply 11 is equal to or higher than a first limit temperature, the controller 12 may interrupt charging of the power supply 11. If the temperature of the power supply 11 is equal to or higher than a second limit temperature, the controller 12 may interrupt use of the power stored in the power supply 11 (e.g., discharging). The controller 12 may calculate the remaining amount of the power stored in the power supply 11. For example, the controller 12 may calculate the remaining capacity of the power supply 11 based on a voltage and/or current detection value of the power supply 11.

According to one embodiment, the controller 12 may control the supply of power to the heater 18 and 24 based on a result of the detection by the sensor unit 13.

According to one embodiment, the controller 12 may control the supply of power to the heater 18 and 24 based on insertion and/or removal of the aerosol-generating article into and/or from the insertion space. For example, upon determining that the aerosol-generating article has been inserted into the insertion space using the insertion detection sensor (e.g., the sensor unit 13), the controller 12 may perform control such that power is supplied to the heater 18 and 24. Upon determining that the aerosol-generating article has been removed from the insertion space using the insertion detection sensor (e.g., the sensor unit 13), the controller 12 may interrupt the supply of power to the heater 18 and 24. The controller 12 may determine that the aerosol-generating article has been removed from the insertion space when the temperature of the heater 18 and 24 is equal to or higher than a limit temperature or when the temperature change slope of the heater 18 and 24 is equal to or greater than a preset slope.

According to one embodiment, the controller 12 may control, based on the state of the aerosol-generating article, a power supply time and/or the amount of power supplied to the heater 18 and 24. For example, upon determining that the aerosol-generating article is in an overly moist state using the overly moist state detection sensor (e.g., the sensor unit 13), the controller 12 may increase a time during which power is supplied to the heater 18 and 24 (e.g., a preheating time).

According to one embodiment, the controller 12 may control the supply of power to the heater 18 and 24 based on whether the aerosol-generating article is being reused. For example, upon determining that the aerosol-generating article has already been used, the controller 12 may interrupt the supply of power to the heater 18 and 24.

According to one embodiment, the controller 12 may control the supply of power to the heater 18 and 24 based on whether the cartridge has been coupled and/or removed. For example, upon determining that the cartridge has been removed using the cartridge detection sensor (e.g., the sensor unit 13), the controller 12 may interrupt the supply of power to the heater 18 or 24 or may perform control such that power is not supplied to the heater 18 and 24.

According to one embodiment, the controller 12 may control the supply of power to the heater 18 and 24 based on whether the aerosol-generating substance in the cartridge has been exhausted. For example, upon determining that the temperature of the heater 18 and 24 exceeds a limit temperature during preheating of the heater 18 and 24 (i.e., in the preheating section), the controller 12 may determine that the aerosol-generating substance in the cartridge has been exhausted. Upon determining that the aerosol-generating substance in the cartridge has been exhausted, the controller 12 may interrupt the supply of power to the heater 18 and 24.

According to one embodiment, the controller 12 may control the supply of power to the heater 18 and 24 based on whether use of the cartridge is possible. For example, upon determining, based on data stored in the memory 17, that the current number of puffs is equal to or greater than the maximum number of puffs set for the cartridge, the controller 12 may determine that use of the cartridge is impossible. Alternatively, when a total time period during which the heater 18 and 24 is heated is equal to or longer than a preset maximum time period or when the total amount of power supplied to the heater 18 and 24 is equal to or greater than a preset maximum amount of power, the controller 12 may determine that use of the cartridge is impossible. In this case, the controller 12 may interrupt the supply of power to the heater 18 or 24 or may perform control such that power is not supplied to the heater 18 and 24.

According to one embodiment, the controller 12 may control the supply of power to the heater 18 and 24 based on the user's puff. For example, the controller 12 may determine whether a puff occurs and/or the intensity of a puff using the puff sensor (e.g., the sensor unit 13). When the number of puffs reaches a preset maximum number of puffs and/or when no puff is detected for a preset time period or longer, the controller 12 may interrupt the supply of power to the heater 18 and 24. When a puff is detected, the controller 12 may control the supply of power to the heater 18 and 24.

According to one embodiment, the controller 12 may control the supply of power to the heater 18 and 24 based on whether the aerosol-generating article (or the cartridge) is authentic and/or the type of the aerosol-generating article (or the cartridge). For example, the controller 12 may determine whether the aerosol-generating article is authentic and/or may determine the type of the aerosol-generating article using the cigarette identification sensor (e.g., the sensor unit 13). In an example, upon determining that the aerosol-generating article (or the cartridge) is inauthentic, the controller 12 may interrupt the supply of power to the heater 18 and 24. Upon determining that the aerosol-generating article (or the cartridge) is authentic, the controller 12 may control (e.g., commence) the supply of power to the heater 18 and 24. In another example, the controller 12 may control the supply of power to the heater 18 and 24 differently depending on the type of the aerosol-generating article (or the cartridge). In more detail, upon determining that the aerosol-generating article (or the cartridge) is a first aerosol-generating article (or a first cartridge), the controller 12 may control the temperature of the heater 18 and 24 and/or power based on a first temperature profile (or a first power profile), and upon determining that the aerosol-generating article (or the cartridge) is a second aerosol-generating article (or a second cartridge), the controller 12 may control the temperature of the heater 18 and 24 and/or power based on a second temperature profile (or a second power profile).

According to one embodiment, the controller 12 may control the output unit 14 based on a result of detection by the sensor unit 13. For example, when the number of puffs counted using the puff sensor (e.g., the sensor unit 13) reaches a preset number, the controller 12 may control the output unit 14 to visually, haptically, and/or audibly provide information that operation of the aerosol-generating device 1 will end soon. For example, the controller 12 may control the output unit 14 to visually, haptically, and/or audibly provide information about the temperature of the heater 18 and 24.

According to one embodiment, based on occurrence of a predetermined event, the controller 12 may store a history of the corresponding event in the memory 17 and may update the history. For example, the event may include events performed in the aerosol-generating device 1, such as detection of insertion of the aerosol-generating article, commencement of heating of the aerosol-generating article, detection of puff, termination of puff, detection of overheating of the heater 18 and 24, detection of application of overvoltage to the heater 18 and 24, termination of heating of the aerosol-generating article, on/off operation of the aerosol-generating device 1, commencement of charging of the power supply 11, detection of overcharging of the power supply 11, and termination of charging of the power supply 11. For example, the history of the event may include the occurrence date and time of the event and log data corresponding to the event. For example, when the predetermined event is detection of insertion of the aerosol-generating article, the log data corresponding to the event may include data on a value detected by the insertion detection sensor (e.g., the sensor unit 13). For example, when the predetermined event is detection of overheating of the heater 18 and 24, the log data corresponding to the event may include data on the temperature of the heater 18 and 24, the voltage applied to the heater 18 and 24, and the current flowing through the heater 18 and 24.

According to one embodiment, the controller 12 may control the communication unit 16 to form a communication link with an external device such as a user's mobile terminal.

According to one embodiment, upon receiving data on authentication from an external device via the communication link, the controller 12 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the controller 12 may transmit data on the state of the aerosol-generating device 1 (e.g., remaining capacity of the power supply 11 and operation mode) to the external device via the communication link. The transmitted data may be output through a display or the like of the external device.

According to one embodiment, upon receiving a request to search for the location of the aerosol-generating device 1 from the external device via the communication link, the controller 12 may control the output unit 14 to perform an operation corresponding to location search. For example, the controller 12 may perform control such that the haptic unit generates vibration or the display outputs objects corresponding to location search and termination of search.

According to one embodiment, upon receiving firmware data from the external device via the communication link, the controller 12 may perform firmware update.

According to one embodiment, the controller 12 may transmit data on a value detected by the at least one sensor unit 13 to an external server (not shown) via the communication link, and may receive, from the server, and store a learning model generated by learning the detected value through machine learning such as deep learning. The controller 12 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 11 in response to overcharging and/or overdischarging of the power supply 11. The aerosol-generating device 1 may further include a connection interface such as a universal serial bus (USB) interface, and may be connected to other external devices through the connection interface to transmit and receive information or charge the power supply 11.

The aerosol-generating article mentioned in the present disclosure may include at least one aerosol-generating rod (e.g., a medium portion) and at least one filter rod. The heater 18 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater 24 may be included in the cartridge in a coil-shaped structure surrounding (or wound around) the liquid delivery part or a structure contacting one side of the liquid delivery part. Alternatively, the cartridge heater 24 may be included in the aerosol-generating device 1, which is removable from the cartridge.

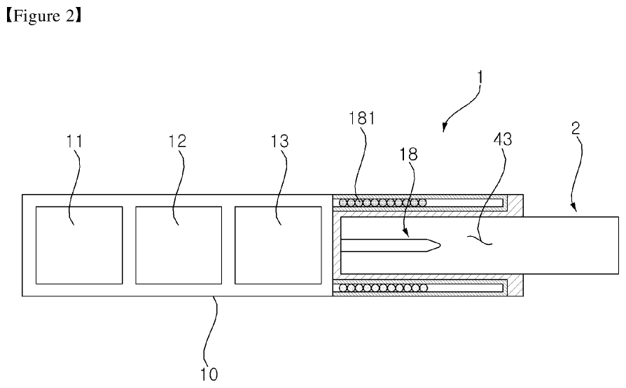

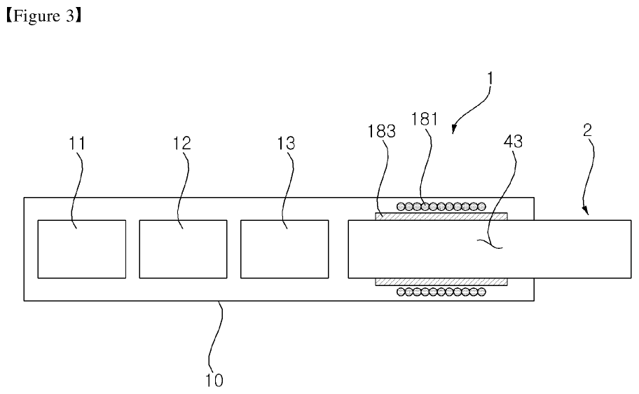

FIGS. 2 and 3 are views showing aerosol-generating devices 1 according to embodiments of the present disclosure.

According to one embodiment, the aerosol-generating device 1 may include a housing 10, a power supply 11, a controller 12, a sensor unit 13, and/or a heater 182 and 183 (e.g., the heater 18 in FIG. 1). However, it will be understood by those skilled in the art related to the present embodiment that the components included in the aerosol-generating device 1 are not limited to those shown in FIG. #a or FIG. #b and that some of the components may be omitted or new components may be further included. The aerosol-generating device 1 shown in FIG. 2 may be referred to as an “internal heating-type”aerosol-generating device that heats the inner side of an aerosol-generating article 2. The aerosol-generating device 1 shown in FIG. 3 may be referred to as an “external heating-type” aerosol-generating device that heats the outer side of the aerosol-generating article 2. In the drawings below, a description of configurations identical to those shown in FIG. 1 will be omitted.

According to one embodiment, the housing 10 may provide a space that is open upwardly to allow the aerosol-generating article 2 to be inserted thereinto. In the present disclosure, the space that is open upwardly may be referred to as an insertion space. The insertion space may be formed so as to be depressed in the housing 10 to a predetermined depth so that at least a portion of the aerosol-generating article 2 may be inserted thereinto. The depth of the insertion space may be equal to or greater than the length of a region of the aerosol-generating article 2 in which an aerosol-generating substance and/or a medium is contained. The lower end of the aerosol-generating article 2 may be inserted into the housing 10, and the upper end of the aerosol-generating article 2 may protrude outside the housing 10. A user may inhale an aerosol while holding the externally exposed upper end of the aerosol-generating article 2 in the mouth.

According to one embodiment, the heater 182 and 183 may heat the aerosol-generating article 2.

Referring to FIG. 2, the heater 182 may be an internal heating-type heater.

According to one embodiment, the internal heating-type heater may be elongated upwardly in the space into which the aerosol-generating article 2 is inserted (i.e., the insertion space). For example, as shown in the drawings, the internal heating-type heater may include a rod-shaped or needle-shaped heating element. Alternatively, the internal heating-type heater may include various other heating elements, such as a tubular heating element or a plate-shaped heating element. The internal heating-type heater may be inserted through the lower portion of the aerosol-generating article 2.

According to one embodiment, the internal heating-type heater may include an electro-resistive heater and/or an induction heater.

For example, the electro-resistive heater may include an electro-resistive material, which is provided on the inner side (e.g., in the cavity or on the inner surface) or outer side (e.g., on the outer surface) thereof, and may generate heat as current flows through the electro-resistive material. In this case, the electro-resistive heater may be electrically connected to the power supply 11, and may directly generate heat using current received from the power supply 11. Meanwhile, an induction coil 181 may be omitted.

For example, in the case of an induction heater, the aerosol-generating device 1 may include an induction coil 181 surrounding at least a portion of the internal heating-type heater (e.g., disposed outside the heater so as to correspond to the length of at least a portion of the heater). In this case, a magnetic flux concentrator may be further provided outside the induction coil 181 in order to increase efficiency of induction heating. The induction heater may include a susceptor, and may generate heat based on a magnetic field generated by the induction coil 181. According to one embodiment, the induction heater (e.g., the susceptor) (or a heater module including the same) may be disposed to be removable from the housing 10.

According to one embodiment, the heater 182 may be a multi-heater. The multi-heater may include a first heater and a second heater, and may be inserted into the aerosol-generating article 2. The first heater and the second heater may be disposed side by side in the longitudinal direction. The first heater and the second heater may operate as an electro-resistive heater and/or an induction heater, and may be heated sequentially or simultaneously. In this case, the first heater and the second heater may be disposed at positions corresponding to the positions of two or more aerosol-generating rods in the longitudinal direction, respectively. Alternatively, the first heater and the second heater may be disposed at positions corresponding to the positions of a first portion and a second portion of one aerosol-generating rod in the longitudinal direction, respectively. Meanwhile, if the heater 182 is an induction heater, the aerosol-generating device 1 may include a first induction coil and a second induction coil, and the first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 182 in the longitudinal direction, respectively. In addition, three or more heaters and/or three or more induction coils may be included.

According to one embodiment, the susceptor may be disposed on (or included in) the inner side (e.g., the medium portion) of the aerosol-generating article 2. The susceptor included inside the aerosol-generating article 2 may be implemented to be heated based on a magnetic field generated by the induction coil 181.

Referring to FIG. 3, the heater 183 may be an external heating-type heater.

According to one embodiment, the external heating-type heater may be elongated upwardly around the space into which the aerosol-generating article 2 is inserted (i.e., the insertion space). For example, the external heating-type heater may be disposed so as to surround at least a portion of the insertion space. In an example, the external heating-type heater may include a tube shape (e.g., a cylindrical shape) including a cavity formed therein. The external heating-type heater may alternatively include a shape including a cavity formed therein and surrounding the cavity. In this case, the external heating-type heater may be supported by a polyimide film. The heater supported by this film may be referred to as a film heater. The external heating-type heater may be disposed so as to surround at least a portion of the insertion space. The external heating-type heater may heat the outer side of the aerosol-generating article 2 inserted into the cavity.

According to one embodiment, the external heating-type heater may include an electro-resistive heater and/or an induction heater, and a description of configurations identical to those shown in FIG. 2 will be omitted. Meanwhile, in the case of an induction heater, the aerosol-generating device 1 may include an external heating-type heater implemented as a tubular susceptor and may include an induction coil 181 surrounding at least a portion of the external heating-type heater (e.g., disposed outside the heater so as to correspond to the length of at least a portion of the heater). In addition, the induction coil 181 may include a fan coil. Meanwhile, if the external heating-type heater is an electro-resistive heater, heat may be generated through current flow through the tubular electro-resistive heater (e.g., the film heater), and thus a separate induction coil 181 may be omitted. Meanwhile, a thermally insulating material may be disposed outside the external heating-type heater. Accordingly, the amount of heat emitted from the heater 183 in the radially outward direction and released outside the housing 10 may be reduced.

According to one embodiment, the heater 183 may be a multi-heater, and the first heater and the second heater may be disposed side by side in the longitudinal direction so as to surround at least a portion of the insertion space. The first heater and the second heater may operate as an electro-resistive heater and/or an induction heater, and may be heated sequentially or simultaneously. Meanwhile, if the heater 183 is an induction heater, the aerosol-generating device 1 may include a first induction coil and a second induction coil. The first induction coil and the second induction coil may be disposed at positions corresponding to the positions of the first heater and the second heater in the longitudinal direction, respectively. Alternatively, the first heater and the second heater may be disposed at positions corresponding to the positions of a first portion and a second portion of one heater 183 in the longitudinal direction, respectively.

Unlike the configuration shown in FIG. 2 or FIG. 3, both the heater 182 in FIG. 2 and the heater 183 in FIG. 3 may be included in the aerosol-generating device 1. In this case, the heater 182 may heat the inner side of the aerosol-generating article 2, and the heater 183 may heat the outer side of the aerosol-generating article 2.

According to one embodiment, the aerosol-generating device 1 may be provided with an airflow channel through which air flows. For example, the housing 10 may include a structure (e.g., a hole) through which outside air may be introduced into the housing 10. The air introduced into the housing 10 may be introduced into the aerosol-generating article 2 through the lower end (i.e., upstream side) of the aerosol-generating article 2. An aerosol generated based on heating of the aerosol-generating article 2 may be inhaled into the user's oral cavity together with the introduced air through the upper end (i.e., downstream side) of the aerosol-generating article 2.

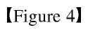

FIG. 4 is a front perspective view of an aerosol-generating device according to one embodiment of the present disclosure.

Referring to FIG. 4, a body 10 (e.g., the housing 10 in FIGS. 2 and 3) may include side walls 101 and 102 that extend lengthwise, a cover 103 that forms one end of the body 10, a base 104 that forms the other end of the body 10, and a door 110 that opens and close an insertion space 43. The body 10 may have a cylindrical shape that extends in one direction.

The body 10 may include the side walls 101 and 102 that form the outer surface of the body 10. The side walls 101 and 102 may include a curved surface extending in the circumferential direction of the body 10.

The side walls 101 and 102 may include a first side wall 101. The first side wall 101 may extend in the circumferential direction of the body 10. The first side wall 101 may be bent in the circumferential direction of the body 10 and form a space therein. The first side wall 101 may have one side that is opened. The cross-section of the first side wall 101 may have a loop shape with one side that is opened.

The side walls 101 and 102 may include a second side wall 102. The second side wall 102 may extend in the longitudinal direction of the body 10. The second side wall 102 may be coupled to the first side wall 101. The second side wall 102 may be located between both ends of the first side wall 101 in the circumferential direction, and form a surface that is continuous with the first side wall 101. The second side wall 102 may cover one side of the first side wall 101 that is opened laterally.

The body 10 may include the cover 103 that forms one end of the body 10 in the longitudinal direction. The cover 103 may be coupled to one end of the first side wall 101 in the longitudinal direction and one end of the second side wall 102 in the longitudinal direction.

The body 10 may include the door 110. The door 110 may be coupled to the cover 103. The door 110 may open and close the insertion space 43 (see FIGS. 2 and 3) in a sliding manner. A rail 105 may be formed on the cover 103. The door 110 may slide along the rail 105.

The body 10 may include the base 104 that forms the other end of the body 10 in the longitudinal direction. The base 104 may be coupled to the other end of the first side wall 101 in the longitudinal direction and the other end of the second side wall 102 in the longitudinal direction.

A button 106 (e.g., the input unit 15 in FIG. 1) may be provided on the body 10. The button 106 may be inserted into a hole formed in one side of the second side wall 102.

A display 141 (e.g., the output unit 14 in FIG. 1) may be provided on the body 10. The display 141 may be disposed on the second side wall 102. The display 141 may extend in the longitudinal direction of the body 10. The display 141 may visually provide information about the aerosol-generating device 1 to the user. The display 141 may be an LED display device, a liquid crystal display (LCD) panel, an organic light emitting diode (OLED) display panel, or the like.

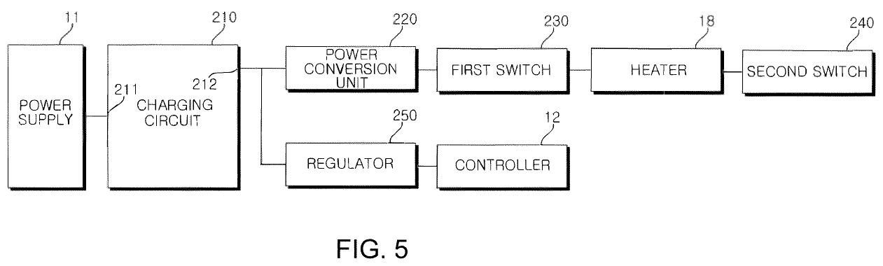

FIG. 5 is a circuit diagram of the aerosol-generating device 1 according to one embodiment of the present disclosure.

Referring to FIG. 5, the aerosol-generating device 1 may include at least one of a power supply 11, a heater 18, or a power conversion unit 220.

The heater 18 may be disposed in the body 10. The heater 18 may receive power from the power supply 11 and heat an insertion space 43 provided in the body 10 and/or a stick 2 (e.g., the aerosol-generating article 2 in FIGS. 2 and 3) inserted into the insertion space 43. The heater 18 may include the features of the heater 18 described in FIGS. 1 to 3.

The power supply 11 may supply power to the heater 18. The power supply 11 may supply power to the heater 18 under the control of the controller 12.

The power conversion unit 220 may be provided between the heater 18 and the power supply 11. The power conversion unit 220 may convert a voltage output from the power supply 11 or a charging circuit 210, which will be described below, into a voltage to be supplied to the heater 18. For example, the power conversion unit 220 may be implemented through a boost converter or a buck-boost converter, which converts the voltage output from the power supply 11 or the charging circuit 210. The power conversion unit 220 may be referred to as a booster, a converter, or a transformer. The power supply unit 220 may convert the voltage output from the power supply 11 or the charging circuit 210 and output the converted voltage. For example, the magnitude of the voltage output from the power supply unit 220 may be equal to or greater than the magnitude of the voltage output from the power supply 11 or the charging circuit 210.

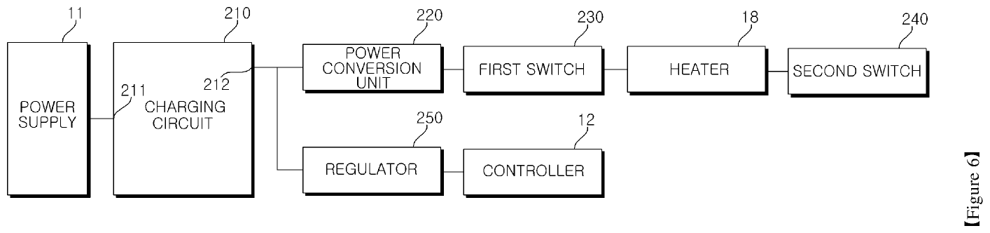

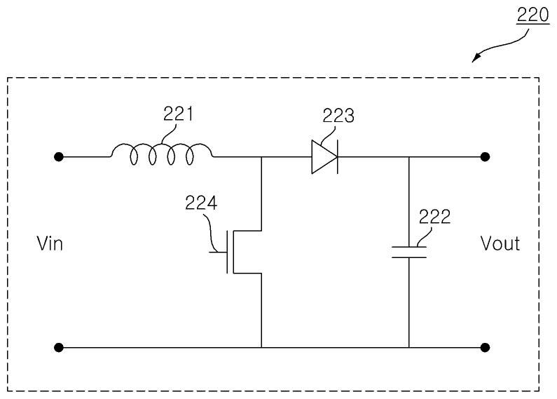

The power supply unit 220 may have an LC resonant circuit to convert the voltage output from the power supply 11 or the charging circuit 210. The LC resonant circuit may be provided with at least one inductor 221 (see FIG. 6) and at least one capacitor 222 (see FIG. 6). The inductor 221 of the power conversion unit 220 may have an inductance value within a specific range. The detailed structure of the power conversion unit 220 will be described in detail with reference to FIG. 6.

The aerosol-generating device 1 may include at least one of the controller 12, the charging circuit 210, a first switch 230, a second switch 240, or a regulator 250.

The charging circuit 210 may be connected to the power supply 11, the power conversion unit 220, and the controller 12. The charging circuit 210 may transmit power supplied from the power supply 11 to the power conversion unit 220 under the control of the controller 12. The charging circuit 210 may be referred to as a charger.

The charging circuit 210 may electrically connect the power supply 11 and the power conversion unit 220. The power supply 11 may be connected to an input terminal 211 of the charging circuit 210, and the power conversion unit 220 may be connected to an output terminal 212 of the charging circuit 210.

The charging circuit 210 may charge the power supply 11 or transmit power to the power conversion unit 220 under the control of the controller 12. For example, if an external power source (not shown) is electrically connected to the aerosol-generating device 1, the charging circuit 210 may supply power supplied from the external power source to the power supply 11 or the power conversion unit 220. The charging circuit 210 may convert the power supplied from the external power source into power suitable for charging the power supply 11. For example, if an external power source is not electrically connected to the aerosol-generating device 1, the charging circuit 210 may transmit power supplied from the power supply 11 to the power conversion unit 220.

The charging circuit 210 may include switching elements therein. For example, the charging circuit 210 may include power switching elements, such as field-effect transistors (FETs), therein. In the ON state of the switching elements in the charging circuit 210, the power supplied from the power supply 11 may be transmitted to elements connected to the output terminal 212 through the input terminal 211 and the output terminal 212 of the charging circuit 210.

The second switch 240 may be connected to the heater 18. One end of the second switch 240 may be connected to the heater 18, and the other end of the second switch 240 may be connected to the ground GND. The second switch 240 may be electrically connected to the heater 18 and the ground GND under the control of the controller 12. Power output from the power conversion unit 220 may be supplied to the heater 18 by the second switch 240. The second switch 240 may be referred to as a PWM switch or a heater switch.

The controller 12 may control power supplied to the heater 18. The controller 12 may control switching of the second switch 240 to supply power to the heater 18 or cut off power supply thereto. The heater 18 may generate heat when power is supplied thereto, and may not generate heat when the power supplied thereto is cut off.

The controller 12 may control the second switch 240 so that a pulse having a predetermined frequency and/or duty ratio is supplied to the heater 18. The controller 12 may control the power supplied to the heater 18 by adjusting the frequency and/or duty ratio of the pulse through the second switch 240.

The controller 12 may derive the temperature of the heater 18. The controller 12 may determine the temperature of the heater 18 based on a signal output from a temperature sensor (not shown). The controller 12 may determine the power to be supplied to the heater 18 based on the determined temperature of the heater 18. The controller 12 may supply the determined power to the heater 18 by controlling at least one of the power supply 11, the charging circuit 210, the power conversion unit 220, or the second switch 240.

The first switch 230 may be provided between the heater 18 and the power conversion unit 220. The first switch 230 may connect the power conversion unit 220 and the heater 18. If an abnormal current flows through the heater 18, the first switch 230 may be turned off to cut off the power supplied to the heater 18. The first switch 230 may be referred to as a load switch.

The controller 12 may receive an output signal from a current sensor (not shown) connected to the heater 18 and determine whether an abnormal current flows through the heater 18 based on the output signal. The controller 12 may cut off the power supplied to the heater 18 by controlling at least one of the charging circuit 210, the power conversion unit 220, the first switch 230, or the second switch 240 based on the current flowing through the heater 18 being greater than a set threshold.

Accordingly, malfunction of the heater 18 may be prevented, and the operating stability of the circuit may be increased.

The regulator 250 may be further provided between the controller 12 and the charging circuit 230. The regulator 250 may connect the output terminal 212 of the charging circuit 210 and the controller 12. The regulator 250 may convert a voltage Vsys output from the charging circuit 210. For example, the regulator 250 may be implemented through a low-dropout regulator that converts the voltage Vsys output from the charging circuit 210, or the like.

Accordingly, a voltage to be applied to the controller 12 may be stabilized.

Although not shown in FIG. 5, the charging circuit 210 may be connected to the heater 18 and the controller 12, and in some embodiments, at least one sensor (e.g., the sensor unit 13 in FIG. 1) and a vibration motor (e.g., the output unit 14 in FIG. 1) may be further connected thereto. A regulator (not shown) may be further provided between the charging circuit 210 and the at least one sensor. A regulator (not shown) may be further provided between the charging circuit 210 and the vibration motor. Each regulator may convert the voltage output from the charging circuit 210.

FIG. 6 is a circuit diagram of the power conversion unit of the aerosol-generating device according to one embodiment of the present disclosure.

Referring to FIG. 6, one end of the power conversion unit 220 may be connected to the power supply 11 through the charging circuit 210, and the other end of the power conversion unit 220 may be connected to the heater 18 or the first switch 230.

The power conversion unit 220 may have a rectifier 223 and a booster switch 224. The booster switch 224 may include at least one switching element. For example, the booster switch 224 may include at least one field-effect transistor (FET). The rectifier 223 may include a diode.

The power conversion unit 220 may have the inductor 221 and the capacitor 222. One end of the inductor 221 may be connected to an input terminal of the power conversion unit 220, and the other end of the inductor 221 may be connected to the booster switch 224. One end of the capacitor 222 may be connected to a cathode of the rectifier 223, and the other end of the capacitor 222 may be connected to the ground. The cathode of the rectifier 223 may be connected to the capacitor 222, and an anode of the rectifier 223 may be connected to the booster switch 224 and the inductor 221. One end of the booster switch 224 may be connected to the anode of the rectifier 223 and the inductor 221, and the other end of the booster switch 224 may be connected to the ground. If the booster switch 224 is a FET, a drain of the booster switch 224 may be connected to the anode of the rectifier 223 and the inductor 221, and a source of the booster switch 224 may be connected to the ground.

The power conversion unit 220 may convert power through ON-OFF operation of the booster switch 224. In the ON state of the booster switch 224, the inductor 221 may be charged, and in the OFF state of the booster switch 224, the capacitor 222 may be charged with energy charged in the inductor 221.

The voltage output from the power conversion unit 220 may be determined by a duty cycle D in which the booster switch 224 is turned on and off. The output voltage Vout of the power conversion unit 220 may be proportional to the input voltage Vin, and may increase as the duty cycle D increases. The output voltage Vout of the power conversion unit 220 may be expressed as follows.

$$V out = V in \times ( 1 / 1 - D )$$

The controller 12 may control the power conversion unit 220. The controller 12 may control the switching operation of the booster switch 224 of the power conversion unit 220. The power conversion unit 220 may boost the input voltage. For example, the power conversion unit 220 may boost the voltage output from the power supply 11 to a set heater voltage (e.g., 4.6 V or 5 V). The power conversion unit 220 may stably transmit the set heater voltage to the heater 18, even if the power of the power supply 11 drops to about half of the set heater voltage (e.g., 2.5 V).

Accordingly, the power supply 11 may have an extended lifespan and stably supply a constant voltage to the heater 18.

The inductor 221 of the power conversion unit 220 may have an inductance within a specific range. For example, the inductance of the inductor 221 may be 0.8 to 1.2 μH. For example, the inductance of the inductor 221 may be 0.9 to 1.1 μH. For example, the inductance of the inductor 221 may be about 1.0 μH.

Results of comparing the current of the inductor 221 depending on the inductance of the inductor 221 are set forth in Table 1 below. Table 1 shows the results when the output voltage of the power conversion unit 220 is 4.6 V.

TABLE 1

| Inductance (H) | 1.5*10\hat{ }−6 | 1.0*10\hat{ }−6 |
|---|---|---|
| Maximum inductor current (A) | 5.8 | 5.56 |

Referring to Table 1, when the inductance of the inductor 221 was 1.5 μH, the measured maximum value of the current flowing through the inductor 221 was 5.8 A. The current flowing through the inductor 221 was generally high in a section where the heater 18 was preheated, and the maximum value was measured in this preheating section. In contrast, when the inductance of the inductor 221 was 1.0 μH, the measured maximum value of the current flowing through the inductor 221 was 5.56 A. In this way, it may be confirmed that, when the inductance of the inductor 221 is 1.0 μH or has a value within a designated range therefrom, the peak current value of the inductor 221 is reduced by about 240 mA.

As the peak current value flowing through the inductor 221 increases, the operation of the power conversion unit 220 may become unstable. According to one embodiment of the present disclosure, when the inductance of the inductor 221 is 1.0 μH or has a value within the designated range therefrom, the peak current flowing through the power conversion unit 220 may be reduced, and the power conversion efficiency of the power conversion unit 220 may be increased.

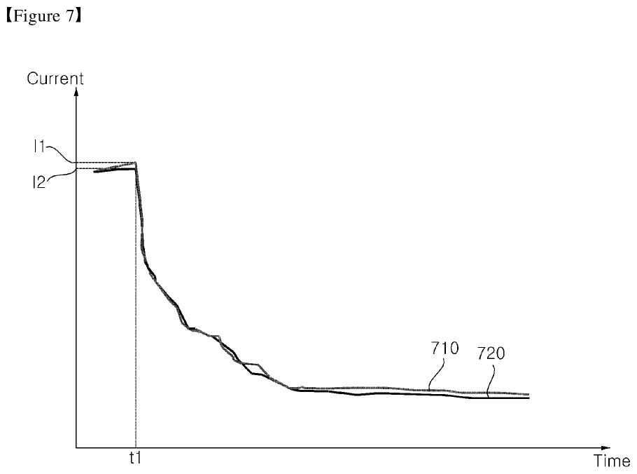

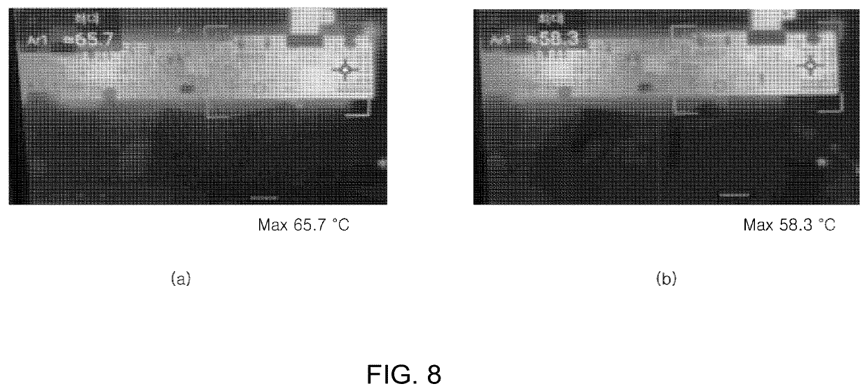

FIG. 7 is a graph comparatively representing the peak current depending on the inductance of the inductor of the power conversion unit of the aerosol-generating device according to one embodiment of the present disclosure, and FIGS. 8(a) and 8(b) are images showing a temperature to which the power conversion unit is heated depending on the inductance of the inductor of the power conversion unit of the aerosol-generating device according to one embodiment of the present disclosure.

Referring to FIGS. 7 and 8 together with FIG. 6, the inductor 221 of the power conversion unit 220 may have a direct current (DC) resistance within a specific range. Here, the DC resistance may indicate a resistance of the inductor 221 if a signal having a frequency close to 0 Hz is applied to the inductor 221. For example, the DC resistance of the inductor 221 may be less than 20 mΩ. For example, the DC resistance of the inductor 221 may be 5 to 10 mΩ. For example, the DC resistance of the inductor 221 may be about 7 mΩ.

Results of comparing the current of the inductor 221 and the temperature of the power conversion unit 220 depending on the DC resistance of the inductor 221 are set forth in Table 2 below. Table 2 shows the results when the output voltage of the power conversion unit 220 is 4.6 V and the inductance of the inductor 221 is 1.0 μH.

TABLE 2

| | | |
|---|---|---|
| DC resistance (Ω) | 7.1*10\hat{ }−3 | 20.0*10\hat{ }−3 |
| Maximum inductor current (A) | 5.99 | 6.42 |
| Power conversion unit | 65.7 | 58.3 |
| temperature (° C.) | | |

Referring to FIG. 7 together with Table 2, when the DC resistance of the inductor 221 was 20.0 mΩ (710 in FIG. 7), the measured maximum value I1 of the current flowing through the inductor 221 was 6.42 A. The current flowing through the inductor 221 was generally high in the section where the heater 18 was preheated, and the maximum value was measured at one point in time t1 during this preheating section. In contrast, when the DC resistance of the inductor 221 was 7.1 mΩ (720 in FIG. 2), the measured maximum value I2 of the current flowing through the inductor 221 was 5.99 A. In this way, it may be confirmed that, when the DC resistance of the inductor 221 is 7.1 mΩ or has a value within a designated range therefrom, the peak current value of the inductor 221 is reduced by about 430 mA.

As the peak current value flowing through the inductor 221 increases, the operation of the power conversion unit 220 may become unstable. According to one embodiment of the present disclosure, when the inductance of the inductor 221 is 7.1 mΩ or has a value within the designated range therefrom, the peak current flowing through the power conversion unit 220 may be reduced, and the power conversion efficiency of the power conversion unit 220 may be increased.

Referring to FIGS. 8(a) and 8(b) together with Table 2, when the DC resistance of the inductor 221 was 20.0 mΩ (in FIG. 8(a)), the measured maximum temperature of the power conversion unit 220 was 65.7° C. The temperature of the power conversion unit 220 also appeared to be generally high in the section where the heater 18 was preheated, and the maximum value of the temperature was measured in this preheating section. In contrast, when the DC resistance of the inductor 221 was 7.1 mΩ (in FIG. 8(b)), the measured maximum temperature of the power conversion unit 220 was 58.3° C.

In this way, it may be confirmed that, when the DC resistance of the inductor 221 is 7.1 mΩ or has a value within a designated range therefrom, the maximum temperature of the power conversion unit 220 is lowered by about 7.4° C.

As the peak current value flowing through the inductor 221 increases, the operation of the power conversion unit 220 may become unstable. According to one embodiment of the present disclosure, when the inductance of the inductor 221 is 7.1 mΩ or has a value within the designated range therefrom, the peak current flowing through the power conversion unit 220 may be reduced, and the operating temperature of the power conversion unit 220 may be lowered, thereby being capable increasing the operating stability of the circuit.

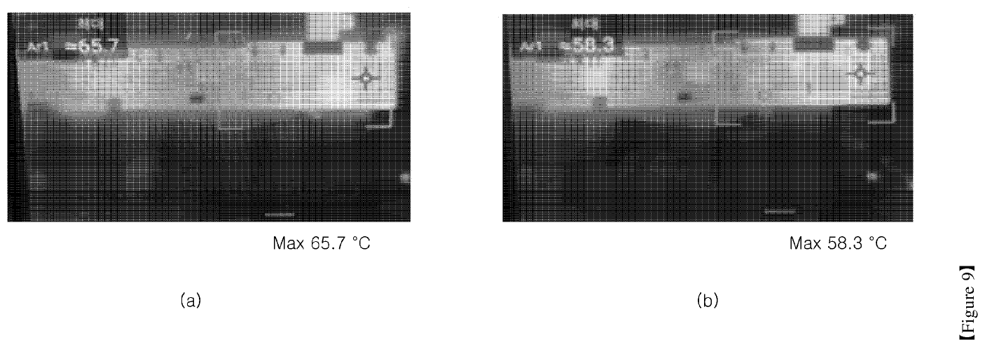

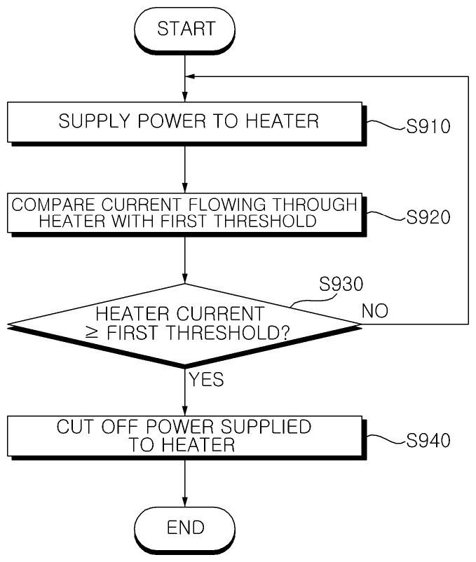

FIG. 9 is a flowchart illustrating power cutoff control of the heater of the aerosol-generating device according to one embodiment of the present disclosure.

Referring to FIG. 9 together with FIG. 5, the controller 12 may supply power to the heater 18 by controlling at least one of the power supply 11, the charging circuit 210, the power conversion unit 220, the first switch 230, or the second switch 240 (S910). The heater 18 may receive power from the power supply 11 and generate heat.

The controller 12 may control whether to supply power to the heater 18 based on a current flowing through the heater 18. The controller 12 may receive an output signal from the current sensor connected to the heater 18, and determine a current value flowing through the heater 18 based on the output signal. The controller 12 may compare the current value flowing through the heater 18 with a first threshold (S920). The first threshold may correspond to the maximum current value at which the heater 18 does not break down or is not deformed or the maximum current value at which the components configured to supply power to the heater 18 may be operated normally during a process of generating heat by the heater 18 through experiments, etc.

If the current value flowing through the heater 18 of the charging circuit 210 is greater than or equal to the first threshold (“Y” in S930), the controller 12 may cut off the power supplied to the heater 18 (S940). For example, the controller 12 may cut off the power supplied to the heater 18 by controlling at least one of the charging circuit 210, the power conversion unit 220, the first switch 230, or the second switch 240. In some embodiments, the controller 12 may cut off the power supplied to the heater 18 by controlling the first switch 230. The first switch 230 may be turned off by the controller 12 so as to cut off the power supplied to the heater 18.

On the other hand, if the current value flowing through the heater 18 of the charging circuit 210 is less than the first threshold (“N” in S930), the controller 12 may control power supply to the heater 18 to be maintained, the process of S910 and the subsequent processes may be repeatedly performed.

An impedance between an output terminal and an input terminal of the first switch 230 may have a resistance within a specific range. For example, the impedance between the output terminal and the input terminal of the first switch 230 may be 10 to 20 mΩ. For example, the impedance between the output terminal and the input terminal of the first switch 230 may be 15 mΩ.

If the impedance between the output terminal and the input terminal of the first switch 230 is 20 mΩ or more, in the state in which the power is supplied to the heater 18, power consumed by the first switch 230 may increase more than necessary, thereby reducing power efficiency. In addition, a voltage drop due to the first switch 230 may increase, thereby reducing a voltage applied to the heater 18.

Accordingly, malfunction of the heater 18 may be prevented, and the operating stability of the circuit may be increased. In addition, even if the first switch 230 to prevent malfunction of the heater 18 is provided, reduction in power efficiency due to the first switch 230 may be minimized.

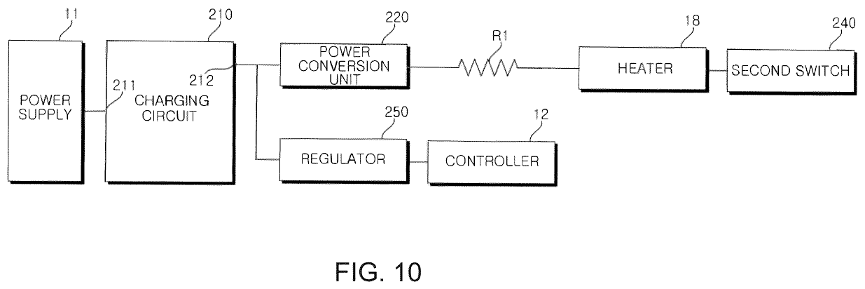

FIG. 10 is a circuit diagram of an aerosol-generating device according to one embodiment of the present disclosure. A detailed description of configurations that overlap with the configurations described in FIG. 5 will be omitted.

Referring to FIG. 10, an aerosol-generating device 1 may include at least one of a power supply 11, a heater 18, a power conversion unit 220, a charging circuit 210, a second switch 240, or a regulator 250.

A first resistor R1 may be provided between the heater 18 and the power conversion unit 220. The first resistor R1 may connect the power conversion unit 220 and the heater 18. The first resistor R1 may be a resistor to detect a current flowing through the heater 18. A current sensor may be connected to the first resistor R1. The first resistor R1 may be referred to a sensing resistor.

The controller 12 may receive an output signal from the current sensor, and determine whether an abnormal current flows through the heater 18 based on the output signal. The controller 12 may cut off the power supplied to the heater 18 by controlling at least one of the charging circuit 210, the power conversion unit 220, or the second switch 240 based on the current flowing through the heater 18 being greater than a set threshold.

Accordingly, malfunction of the heater 18 may be prevented, and the operating stability of the circuit may be increased.

The first resistor R1 may have a resistance within a specific range. For example, the resistance of the first resistor R1 may be 1 to 3 mΩ. For example, the resistance of the first resistor R1 may be 2 mΩ.

Accordingly, malfunction of the heater 18 may be prevented through at least one of the charging circuit 210, the power conversion unit 220, or the second switch 240. In addition, because the resistance of the first resistor R1 to detect the current flowing through the heater 18 has a value smaller than the impedance of the switching element (e.g., the first switch 230), reduction in power efficiency due to the first resistor R1 may be minimized.

Furthermore, the power cutoff control of the heater 18 shown in FIG. 9 may also be applied to the embodiment of FIG. 10. For example, in the process of S920, the controller 12 may determine a current value flowing through the heater 18 based on an output signal from a current sensor connected to the first resistor R1, and compare the current value with a first threshold. For example, in the process of S940, the controller 12 may cut off the power supplied to the heater 18 by controlling at least one of the charging circuit 210, the power conversion unit 220, or the second switch 240.

As described above, according to at least one of the embodiments of the present disclosure, an inductor of a power conversion unit may have an inductance within a specific range, thereby being capable of reducing a peak current flowing through the power conversion unit and increasing power conversion efficiency.

According to at least one of the embodiments of the present disclosure, an inductor of a power conversion unit may have a DC resistance within a specific range, thereby being capable of reducing a peak current flowing through the power conversion unit, lowering the operating temperature of the power conversion unit, and thus increasing the operating stability of a circuit.

According to at least one of the embodiments of the present disclosure, a circuit that cuts off power supplied to a heater based on a current value flowing through the heater may be provided, thereby being capable of preventing malfunction of the heater and increasing the operating stability of the circuit.

Referring to FIGS. 1 to 10, an aerosol-generating device 1 according to one aspect of the present disclosure may include a heater 18 configured to heat an aerosol-generating substance, a power supply 11 configured to supply power to the heater 18, and a power conversion unit 220 configured to convert a voltage output from the power supply 11 into a voltage to be supplied to the heater 18, the power conversion unit 220 may include an inductor 221 connected to the power supply 11, and an inductance of the inductor 221 may be 0.8 to 1.2 μH.

In addition, according to another aspect of the present disclosure, the inductance of the inductor 221 may 0.9 to 1.1 μH.

In addition, according to another aspect of the present disclosure, the power conversion unit 220 may include a boost converter configured to boost the voltage output from the power supply 11.

In addition, according to another aspect of the present disclosure, a DC resistance of the inductor 221 may be less than 20 mΩ.

In addition, according to another aspect of the present disclosure, the DC resistance of the inductor 221 may be 5 to 10 mΩ.

In addition, according to another aspect of the present disclosure, the aerosol-generating device 1 may further include a load switch 230 configured to connect the power conversion unit 220 and the heater 18 and transmit power output from the power conversion unit 220 to the heater 18.

In addition, according to another aspect of the present disclosure, the load switch 230 may be configured to be turned off to cut off the power supplied to the heater 18, in case a current flowing through the heater 18 is greater than or equal to a first threshold.

In addition, according to another aspect of the present disclosure, an impedance between an output terminal and an input terminal of the load switch 230 may be 10 to 20 mΩ.

In addition, according to another aspect of the present disclosure, the aerosol-generating device 1 may further include a first resistor R1 connecting the power conversion unit 220 and the heater 18.

In addition, according to another aspect of the present disclosure, a resistance of the first resistor R1 may be 1 to 3 mΩ.

In addition, according to another aspect of the present disclosure, the power conversion unit 220 may be configured to be turned off to cut off the power supplied to the heater 18, in case a current flowing through the heater 18 is greater than or equal to a second threshold.

In addition, according to another aspect of the present disclosure, the aerosol-generating device 1 may further include a controller 12 configured to control the power supplied to the heater 18 by controlling operation of at least one of the heater 18 or the power conversion unit 220.

In addition, according to another aspect of the present disclosure, the aerosol-generating device 1 may further include a heater switch 240 having one end 241 that is connected to the heater 18 and the other end 242 that is grounded, and the controller 12 may be configured to control the heater switch 240 to supply a pulse having a specific frequency and/or duty ratio to the heater 18.

In addition, according to another aspect of the present disclosure, the aerosol-generating device according may further include a charging circuit 210 configured to connect the power supply 11 and the power conversion unit 220 and transmit the power supplied from the power supply 11 to the power conversion unit 220.

Certain embodiments or other embodiments of the disclosure described above are not mutually exclusive or distinct from each other. Any or all elements of the embodiments of the disclosure described above may be used in combination with each other or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

The above detailed description should not be construed as being limiting in all respects but should be construed as being illustrative. The scope of the disclosure should be determined by a reasonable interpretation of the accompanying claims, and all changes within the equivalent scope of the disclosure are intended to be within the scope of the disclosure.

What is claimed is:

1. An aerosol-generating device comprising:
a heater configured to heat an aerosol-generating substance;
a power supply configured to supply power to the heater; and
a power conversion unit configured to convert a voltage output from the power supply into a voltage to be supplied to the heater,
wherein:
the power conversion unit comprises an inductor connected to the power supply; and
an inductance of the inductor is 0.8 to 1.2 μH.

2. The aerosol-generating device according to claim 1, wherein the inductance of the inductor is 0.9 to 1.1 μH.

3. The aerosol-generating device according to claim 1, wherein the power conversion unit comprises a boost converter configured to boost the voltage output from the power supply.

4. The aerosol-generating device according to claim 1, wherein a DC resistance of the inductor is less than 20 mΩ.

5. The aerosol-generating device according to claim 4, wherein the DC resistance of the inductor is 5 to 10 mΩ.

6. The aerosol-generating device according to claim 1, further comprising a load switch configured to connect the power conversion unit and the heater and transmit power output from the power conversion unit to the heater.

7. The aerosol-generating device according to claim 6, wherein, the load switch is configured to be turned off to cut off the power supplied to the heater, in case a current flowing through the heater is greater than or equal to a first threshold.

8. The aerosol-generating device according to claim 7, wherein an impedance between an output terminal and an input terminal of the load switch is 10 to 20 mΩ.

9. The aerosol-generating device according to claim 1, further comprising a first resistor connecting the power conversion unit and the heater.

10. The aerosol-generating device according to claim 9, wherein a resistance of the first resistor is 1 to 3 mΩ.

11. The aerosol-generating device according to claim 9, wherein, the power conversion unit is configured to be turned off to cut off the power supplied to the heater, in case a current flowing through the heater is greater than or equal to a second threshold.

12. The aerosol-generating device according to claim 1, further comprising a controller configured to control the power supplied to the heater by controlling operation of at least one of the heater or the power conversion unit.

13. The aerosol-generating device according to claim 12, further comprising a heater switch having one end connected to the heater and the other end grounded,
wherein the controller is configured to control the heater switch to supply a pulse having a specific frequency and/or duty ratio to the heater.

14. The aerosol-generating device according to claim 12, further comprising a charging circuit configured to connect the power supply and the power conversion unit and transmit the power supplied from the power supply to the power conversion unit.
